(19) United States
(12) Patent Application Publication
(10) Pub. No.: US 2019/0057065 A1
(43) Pub. Date: Feb. 21, 2019

(54) MODELING DEVICE

(71) Applicant: Hitachi, Ltd., Tokyo (JP)

(72) Inventors: Yoshiyasu TAKAHASHI, Tokyo (JP); Yumiko ISHIDO, Tokyo (JP)

(21) Appl. No.: 16/075,275

(22) PCT Filed: Apr. 1, 2016
(86) PCT No.: PCT/JP2016/060968

§ 371 Date: Aug. 3, 2018

(51) Int. Cl. G06F 17/18; G06N 99/00

(52) U.S. Cl. CPC G06F 17/18; G06N 99/005

(57) ABSTRACT

A modeling device models observation data and includes a database unit that stores a mathematical model based on environment data obtained from the observation data, a statistical model based on a parameter, and region information including each point at which the observation data is obtained; a data reading unit that acquires the observation data and the environment data; and a modeling processing unit that applies the mathematical model or the statistical model. The modeling processing unit calculates a model output by applying the acquired environment data to the mathematical model at each point included in the region information. When a difference between the calculated model output and the acquired observation data is determined to be equal to or greater than a preset threshold, the modeling processing unit calculates a parameter from the acquired observation data and applies the statistical model using the calculated parameter.

### BACKGROUND OF THE INVENTION

### 1. Field of the Invention

The present invention relates to a modeling device.

### 2. Description of Related Art

As a background technology of the invention, there is the technology disclosed in JP-A-2004-86896. According to JP-A-2004-86896, “to provide an adaptive prediction model construction method or an adaptive prediction model construction system capable of efficiently constructing a model using time-series data with high precision,” “when an error of a prediction value output from a prediction model increases, that is, a feature of time-series data learned by the prediction model is different from a feature of time-series data at a prediction time point, a model is updated by relearning the prediction model. When the error increases more, that is, it is necessary to reexamine the prediction model on the whole, a model configuration is also changed to reexamine the prediction model on the whole. Therefore, the adaptive prediction model construction method or the adaptive prediction model construction system capable of efficiently constructing a prediction model with high prediction precision is provided.”

In modeling of a system in the real world, there are a method of using a mathematical model based on physical or mathematical principles and a method of using a statistical model by learning. In the method of using a mathematical model, there are the advantages that constraints such as absolute constraints which are necessarily obeyed can be expressed or a relational expression or the like established between parameters can be expressed. By defining such constraints difficult in learning, it is easy to model a system and predict a behavior of a model. Therefore, it is easy to handle the model.

In the method of using a statistical model, on the other hand, there are the advantages that previously unclear constraints or constraints difficult to input because of being very detailed can be input often. As disclosed in JP-A-2004-86896, there is the advantage that a prediction model which is a statistical model is easily adapted to a recent situation by learning.

In an actual system, there are both a portion in which a parameter or a behavior is determined to be explicit and a portion known to be implicit. A mathematical model is suitable for the former modeling and a statistical model is suitable for the latter modeling. However, in the technology disclosed in JP-A-2004-86896, handling a statistical model is described and the description of the handling of the mathematical model is not found.

### SUMMARY OF INVENTION

Accordingly, the invention provides a technology for facilitating prediction of a behavior of a model using a mathematical model and a statistical model together.

To resolve the foregoing problems, for example, configurations described in the claims are adopted. The present specification includes a plurality of solutions to resolve the foregoing problems, for example, a modeling device for modeling observation data and includes a database unit that stores a mathematical model based on environment data obtained from the observation data, a statistical model based on a parameter, and region information including each point at which the observation data is obtained; a data reading unit that acquires the observation data and the environment data; and a modeling processing unit that applies the mathematical model or the statistical model. The modeling processing unit calculates a model output by applying the acquired environment data to the mathematical model at each point included in the region information. When a difference between the calculated model output and the acquired observation data is determined to be equal to or greater than a preset threshold, the modeling processing unit calculates a parameter from the acquired observation data and applies the statistical model using the calculated parameter.

According to the invention, it is possible to use a mathematical model and a statistical model together and it is possible to facilitate prediction of a behavior of a model.

### BRIEF DESCRIPTION OF THE DRAWINGS

FIG. 1 is a diagram illustrating an example of a configuration of a system;

FIG. 2 is a diagram illustrating an example of a hardware configuration of a modeling device;

FIG. 3 is a diagram illustrating an example of a data structure of external data;

FIG. 4 is a diagram illustrating an example of a data structure of internal data;

FIG. 5 is a diagram illustrating an example of a data structure of statistical model information;

FIG. 6 is a diagram illustrating an example of a data structure of mathematical model information;

FIG. 7 is a diagram illustrating an example of a data structure of region partition information;

FIG. 8 is a diagram illustrating an example of a modeling process flow of the system;

FIG. 9A is a diagram illustrating an example of a modeling process flow related to a mathematical model;

FIG. 9B is a diagram illustrating an example of a modeling process flow related to a statistical model;

FIG. 10 is a diagram illustrating an example of a prediction process flow of the system;

FIG. 11 is a diagram illustrating an example of a prediction process flow for prediction calculation;

FIG. 12A is a diagram illustrating an example of a modeling correction process flow related to a pre-applied model;

FIG. 12B is a diagram illustrating an example of a modeling correction process flow related to a statistical model;

FIG. 13 is a diagram illustrating an example of a model input, estimation, and correction screen;

FIG. 14 is a diagram illustrating an example of a screen for manually inputting the region partition information; and

FIG. 15 is a diagram illustrating an example of a screen for manually inputting 2-dimensional region partition information.

### DESCRIPTION OF EMBODIMENTS

Modes for carrying out the invention will be described with reference to the following drawings.

### 1. System Configuration

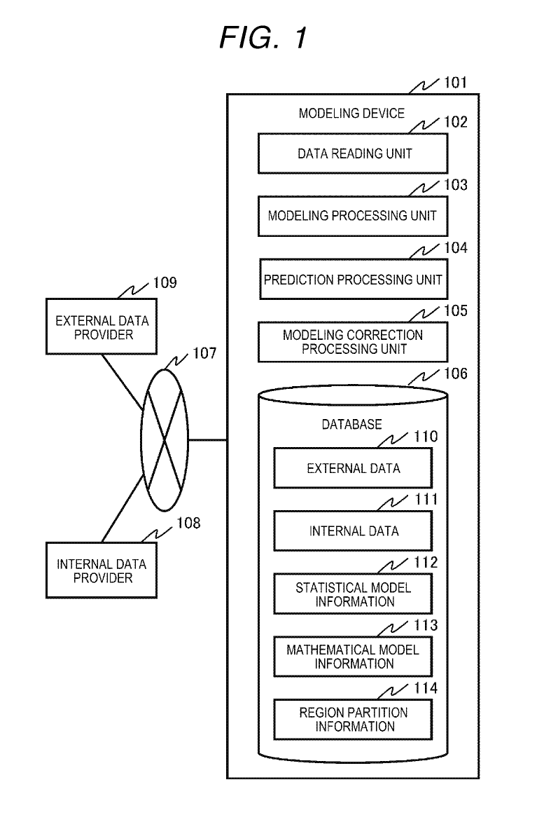

First, a configuration of a system will be described with reference to FIG. 1. FIG. 1 is a diagram illustrating an example of a configuration of a system. In FIG. 1, a modeling device 101 is a device that constructs a model of a modeling target and performs a simulation using the constructed model, and includes a data reading unit 102, a modeling processing unit 103, a prediction processing unit 104, a modeling correction processing unit 105, and a database 106. Here, the modeling target is, for example, observation data of a sensor.

The data reading unit 102 is a processing unit that performs a process of receiving data provided by an external data provider 109 or an internal data provider 108 as an input. The modeling processing unit 103 is a processing unit that partitions a modeling target region and performs mathematical modeling and statistical modeling. The prediction processing unit 104 is a processing unit that performs a prediction process. The modeling correction processing unit 105 is a modeling correction processing unit that corrects modeling while performing a prediction process.

The database 106 is a processing unit that retains the data and provides the data to each processing unit. As the data managed by the database 106, there are external data 110, internal data 111, statistical model information 112, mathematical model information 113, and region partition information 114. A network 107 is a communication medium that connects the modeling device 101 to devices such as the internal data provider 108 and the external data provider 109 and is local area network (LAN) or the Internet.

The internal data provider 108 is a device that provides internal data online. Here, internal data is data for which data serving as a parameter can be observed much in addition to modeling target data. In general, the sensor is installed independently. When much sensor data or the like can be acquired in addition to sensor data which is the modeling target data, the data becomes internal data.

The external data provider 109 is a device that provides external data online. Here, external data is data for which only data serving as parameter can be acquired in addition to the modeling target data. In general, external data is data of other companies, and parameter data may not be opened and acquired except for the modeling target data in some cases.

The external data 110 is information which is acquired from the external data provider 109 and is managed as one piece of data managed by the database 106. The internal data 111 is data which is acquired from the internal data provider 108 and is managed as one piece of data managed by the database 106.

The statistical model information 112 is information such as mathematical expression that expresses statistical model and is managed as one piece of data managed by the database 106. The mathematical model information 113 is information such as mathematical expression expressing mathematical model and is managed as one piece of data managed by the database 106. The region partition information 114 is information regarding partition of the modeling target region and is managed as one piece of data managed by the database 106.

In the embodiment, further, an example will be described assuming that the modeling device 101 models a production quantity of oil, the internal data provider 108 provides information regarding a well or a production quantity, and the external data provider 109 provides only a production quantity and a position of the well.

The embodiment is not limited to only the production quantity of oil, but a production quantity of iron or the like may be used. When a production quantity of iron is modeled, it may be assumed that the internal data provider 108 provides temperature or the like of melt iron and the external data provider 109 provides environment information such as temperature.

Each unit of the modeling device 101 may be configured with dedicated hardware or may be configured by causing a central processing unit (CPU) to execute a program equivalent to each unit. A part of the modeling device 101 may be configured with dedicated hardware and other parts may be configured by causing the CPU to execute a program. Hereinafter, an example in which the modeling device 101 is configured by causing the CPU to execute a program equivalent to each unit will be described.

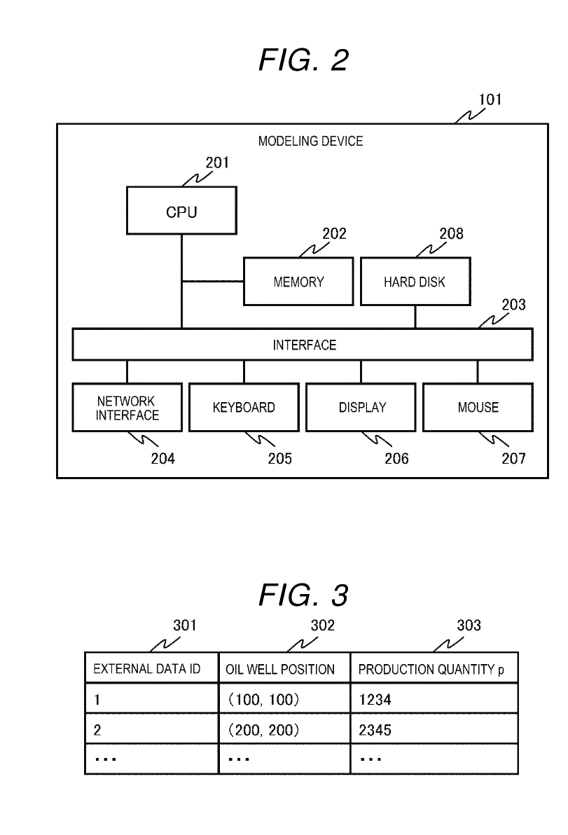

FIG. 2 is a diagram illustrating an example of a hardware configuration of the modeling device 101 and a diagram illustrating a configuration of a general personal computer (PC). The internal data provider 108 and the external data provider 109 may also be configured similarly. In FIG. 2, a CPU 201 is a central processing unit and is a device that executes a program recorded in a memory 202 or transmitted from a hard disk 208 to the memory 202 in advance.

The program may be introduced by a storage medium which can be accessed by the modeling device 101 and can be detachably mounted, as necessary. In this case, a device that reads the storage medium is connected to an interface 203. As the storage medium and the device reading the storage medium, an optical disc (a CD, a DVD, a Blu-ray disc: registered trademark) and a drive therefor, a flash memory and a read and writer therefor are generally known and may be used.

The program may be introduced to the modeling device 101 via a communication medium (a communication line or a carrier wave on a communication line) and may be stored in the hard disk 208, as necessary, by a network interface 204. The memory 202 temporarily records a program or data.

The interface 203 is an interface that enables each unit to communicate with each other in the modeling device 101 and each unit in the modeling device 101 is connected. The network interface 204 is a device that communicates with a PC or the like, other than the modeling device 101. In the embodiment, the network interface 204 is connected to the network 107.

A keyboard 205 is a device that is operated by an operator of the modeling device 101 to input an instruction or data to the modeling device 101. A display 206 is a device that displays a processing result or the like on a screen. A mouse 207 is a device that designates a position on a screen of the display 206 and delivers any action to the CPU 201 by allowing the operator to move a pointer displayed on the screen of the display 206 and press a button at any location.

The display 206 and the mouse 207 or the like may be replaced with a touch panel. In this case, the pointer is not necessary. The hard disk 208 is a device that stores a program and data and includes, for example, a magnetic disk or a nonvolatile memory. In this case, the program and the data stored in the hard disk 208 is normally retained even when the hard disk 208 is turned off and subsequently turned on.

The hard disk 208 may store an operating system (OS) in advance. In this way, for example, a program can be designated using a file name. Here, the OS is basic software of a computer and an OS which is generally widely known may be used.

The stored program may include programs equivalent to the data reading unit 102, the modeling processing unit 103, the prediction processing unit 104, the modeling correction processing unit 105, and the database 106. The program equivalent to the database 106 may be a database program which is generally widely used.

### 2. Data Structure

Hereinafter, a data structure will be described with reference to FIGS. 3 to 7. First, an example of the data structure of the external data 110 according to the embodiment will be described with reference to FIG. 3. An external data ID 301 illustrated in FIG. 3 is a number of uniquely specifying external data, an oil well position 302 is a coordinate position in an index of an oil well, and a production quantity (p) 303 is a production quantity of oil.

For example, the external data ID 301 which is “1” indicates that the oil well position 302 is “(100, 100)” and the production quantity (p) 303 is “1234.” The external data 110 is intended data which is rarely acquired in addition to a modeling target value in the system. In the example of FIG. 3, a value of the production quantity (p) 303 indicates an observation value by a sensor, but is a modeling target value which should be obtained by prediction, and indicates a situation in which only information of the oil well position 302 can be used in the modeling of the value.

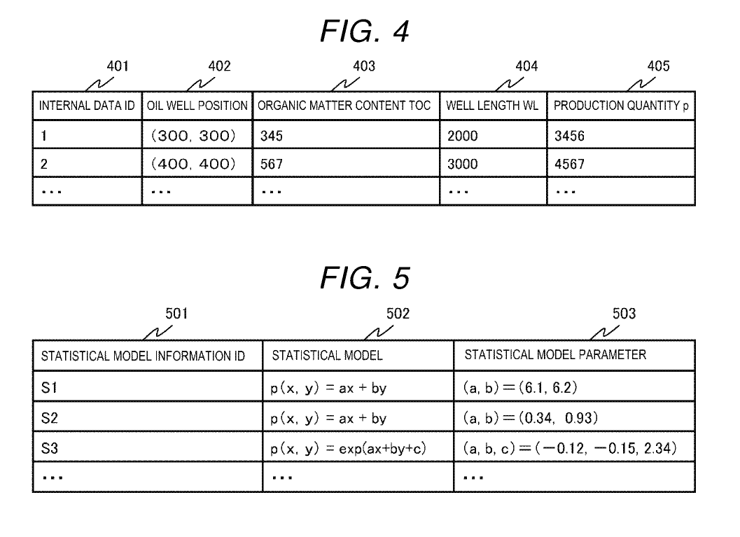

Next, an example of a data structure of the internal data 11 according to the embodiment will be described with reference to FIG. 4. An internal data ID 401 illustrated in FIG. 4 is a number for uniquely specifying internal data, an oil well position 402 is a coordinate position in the index of an oil well, an organic matter content (TOC) 403 is a content of organic material in strata, a well length (WL) 404 is the length of a well, and a production quantity (p) 405 is a production quantity of oil.

For example, the internal data ID 401 which is 1 indicates that the oil well position 402 is (300, 300), the organic matter content (TOC) 403 is 345, the well length (WL) 404 is 2000, and the production quantity (p) 405 is 3456.

The internal data 111 is intended data for which a parameter of the modeling target value can be acquired in addition to the modeling target value. In the example of FIG. 4, the production quantity (p) 405 indicates an observation value by a sensor, but is a modeling target value which should be obtained by prediction, and indicates that the organic matter content (TOC) 403 or the well length WL 404 can be used in the modeling of the value in addition to the oil well position 402. The organic matter content (TOC) 403 and the well length WL 404 can be said to be information regarding an environment in which the production quantity (p) 405 can be obtained.

Next, an example of a data structure of the statistical model information 112 according to the embodiment will be described with reference to FIG. 5. A statistical model information ID 501 illustrated in FIG. 5 is a number for uniquely specifying statistical model information, a statistical model 502 is an expression of the statistical model, and a statistical model parameter 503 is a parameter in the statistical model.

For example, the statistical model information ID 501 which is S1 indicates that the statistical model 502 is p(x, y)=ax+by and the statistical model parameter 503 is (a, b)=(6.1, 6.2). Here, p indicates a production quantity and corresponds to the production quantity (p) 303 and the production quantity (p) 405, and x and y indicate a coordinate position in the index of an oil well and correspond to the oil well positions 302 and 402.

For the statistical model information, a statistical model parameter is determined by machine learning. For example, the statistical model information ID 501 which is S1 indicates that the statistical model is expressed as a linear sum of x and y. In particular, values of a and b are 6.1 and 6.2 as a result of the machine learning and the statistical model parameter.

As the statistical model, additionally, for example, the statistical model information ID 501 which is S3 indicates that p(x, y)=exp(ax+by+c) and is expressed as an exponential function. In addition, a logarithmic function, a trigonometric function, a quadratic or more polynomial, or the like may be used.

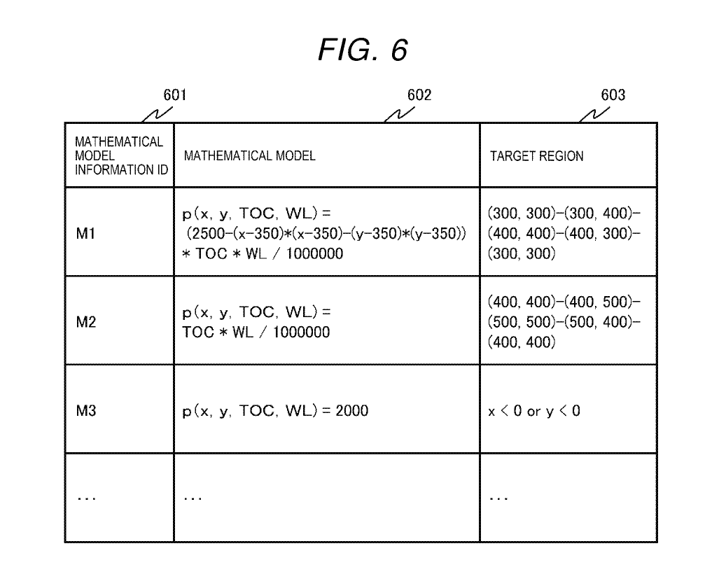

Next, an example of a data structure of the mathematical model information 113 according to the embodiment will be described with reference to FIG. 6. A mathematical model information ID 601 illustrated in FIG. 6 is a number for uniquely specifying mathematical model information, a mathematical model 602 is an expression of the mathematical model, and a target region 603 is a region which is a mathematical model target.

The target region 603 is indicated by a polygon with multiple vertexes and is assumed to turn a target region clockwise in the embodiment. Also, the first vertex and the final vertex are the same and one vertex (x, y) is a coordinate position in an index. Further, although not illustrated, a region in which there is a hole may be designated. In this case, a plurality of polygons may be defined, the second polygon may be inside the first polygon, and the turning order may be counterclockwise. In this way, a region inside the first polygon and outside the second polygon may be designated.

For example, in which the mathematical model information ID 601 is M1 indicates that the mathematical model 602 is p(x, y, TOC, WL)=(2500−(x−350)*(x−350)−(y−350)*(y−350)*TOC*WL/1000000 and the target region 603 is (300, 300)−(300, 400)−(400, 400)−(400, 300)−(300, 300).

Here, p indicates a production quantity and corresponds to the production quantity (p) 303 and the production quantity (p) 405, x and y indicate a coordinate position in the index of an oil well and correspond to the oil well positions 302 and 402, TOC indicates a content of organic material and corresponds to the organic matter content (TOC) 403, and WL indicates a length of a well and corresponds to the well length (WL) 404.

The mathematical model information 113 is a model which is set in advance by the operator or the like and, for example, an oil production system obeys based on a predetermined principle. The mathematical model 602 is set in the target region 603 so that the target region 603 is in each mathematical model information ID 601. However, there may be a region overlapping the target region 603 and plurality of mathematical model 602 may be set in the region.

In the example illustrated in FIG. 6, the parameters TOC and WL indicated in the internal data 111 are used as the mathematical model 602. But this is because information indicating that the internal data 111 can be acquired in the target region 603 can be obtained at the time of defining the mathematical model 602 and is set as definition for use. The mathematical model 602 may be defined in the target region 603 in which only the external data 110 can acquire. In this case, the mathematical model 602 is a mathematical model in which the parameters of the external data 110 are used.

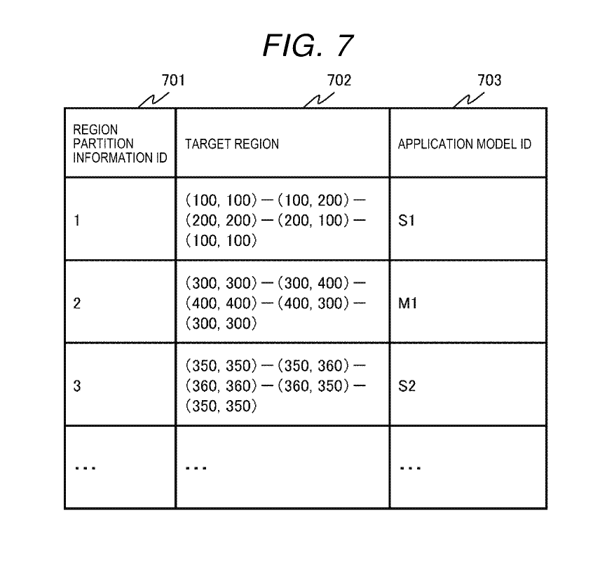

Next, a data structure of the region partition information 114 according to the embodiment will be described with reference to FIG. 7. A region partition information ID 701 illustrated in FIG. 7 is a number for uniquely specifying a region partition information, a target region 702 is a region to be targeted, and an application model ID 703 is the statistical model information ID 501 or the mathematical model information ID 601 to be applied.

For example, the region partition information ID 701 which is 1 indicates that the target region 702 is (100, 100)−(100, 200)−(200, 200)−(200, 100)−(100, 100) and the application model ID 703 is S1 of the statistical model information ID 501. The region partition information ID 701 and the target region 702 may be set in advance by the operator or the like. Further, FIG. 7 illustrates an example in which the application model ID 703 is set in each target region 702, but plurality of application model ID 703 may be set in one target region 702.

The region partition information 114 indicates which model may be applied to the target region 702 which is each of the partitioned regions. A certain coordinate position may be included in a plurality of regions, that is, may be included in plurality of target region 702. In this case, an output of the model at the coordinate position is a sum of outputs of models indicated by plurality of application model ID 703 corresponding to plurality of target region 702 including the coordinate position.

### 3. Process Flow and Screen

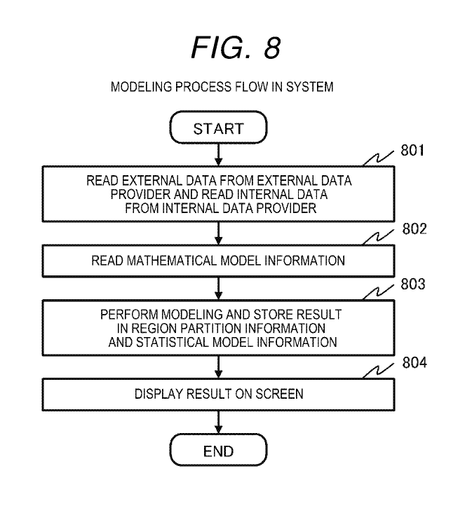

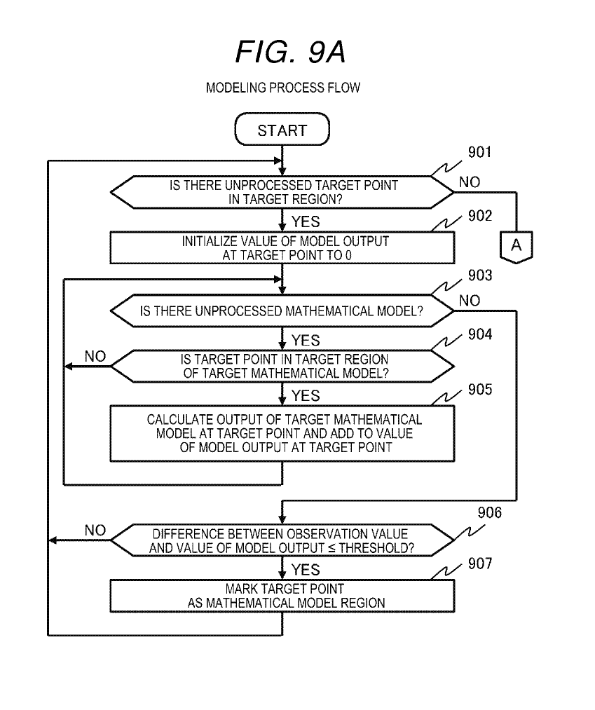

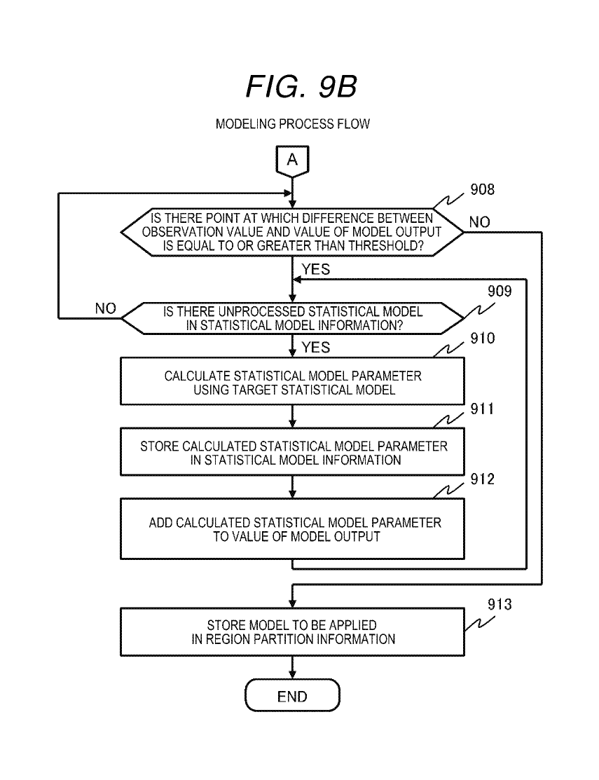

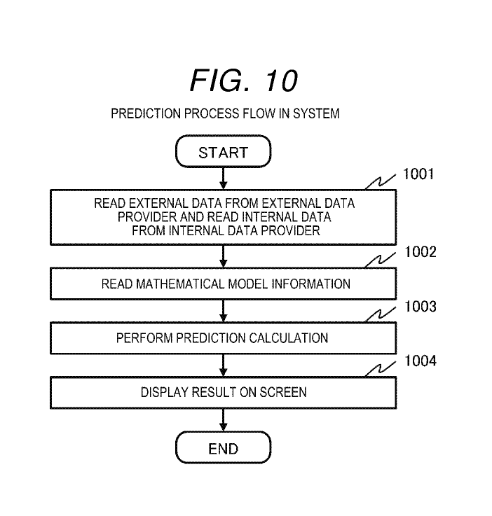

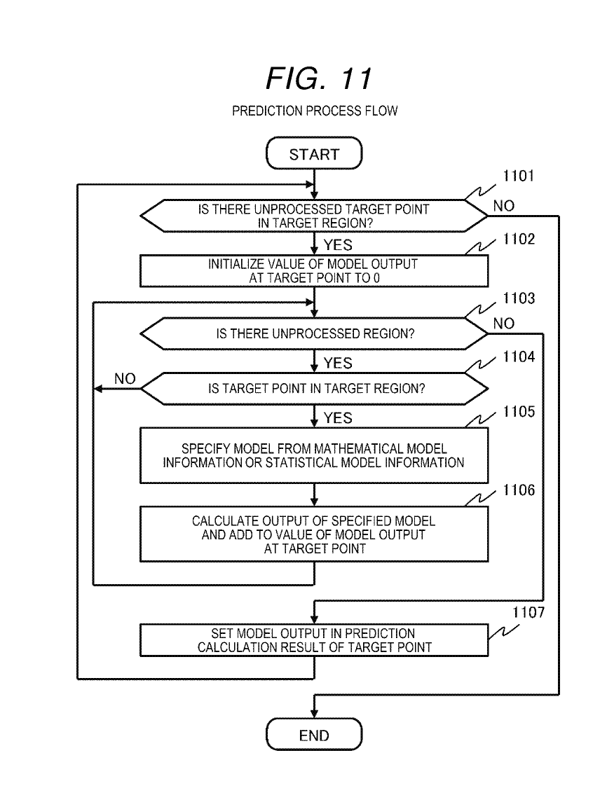

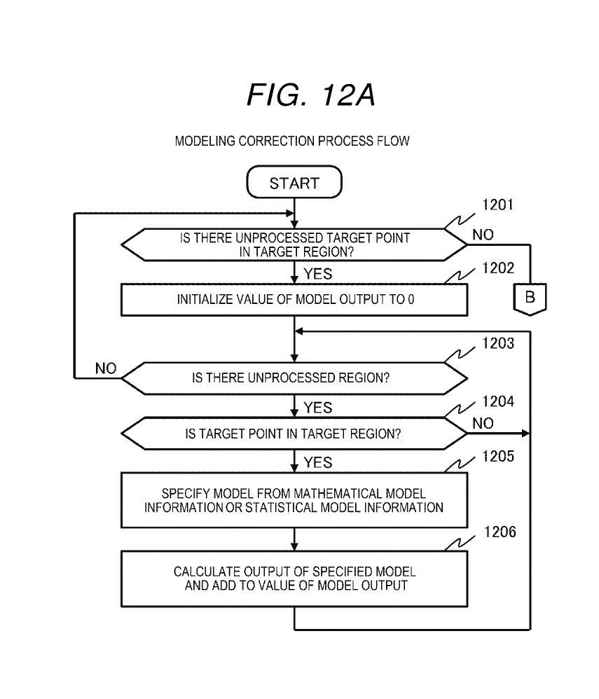

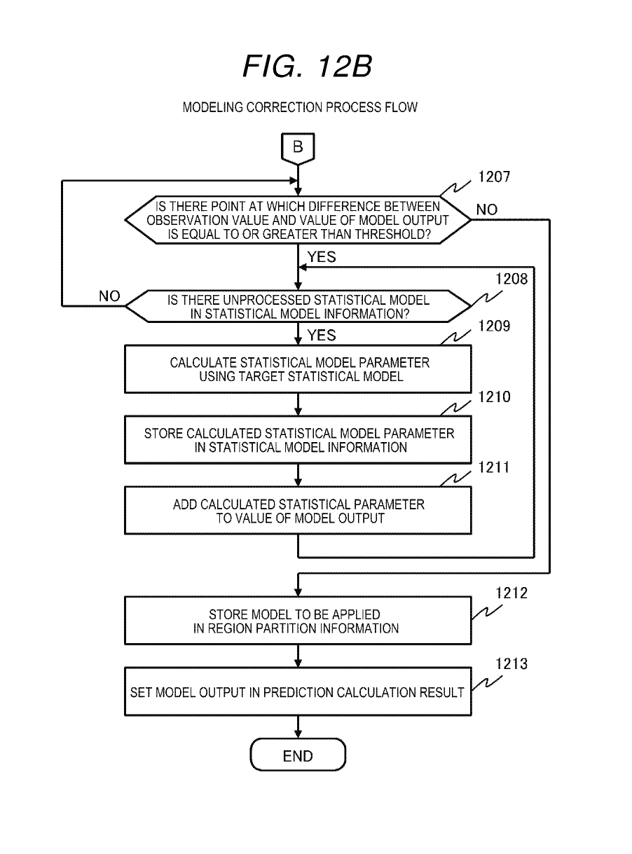

Up to here, the data structures have been described. Hereinafter, process flows and screens will be described. The description of the process flows include description of a modeling process flow for allocating a model to a region with reference to FIGS. 8, 9A, and 9B, description of a prediction process flow for predicting a new position with reference to FIGS. 10 and 11, and description of a modeling correction process flow for correcting the allocated model with reference to FIGS. 12A and 12B.

First, an example of the modeling process flow of the system according to the embodiment will be described with reference to FIG. 8. Step 801 is a process in which the CPU 201 of the modeling device 101 executes a program of the data reading unit 102 and reads the external data 110 and the internal data 111 from the external data provider 109 and the internal data provider 108 via the network 107.

Here, the reading of the external data 110 from the external data provider 109 may be performed via Internet with, for example, a general protocol such as File Transfer Protocol (FTP) or Hyper Text Transfer Protocol (HTTP). The reading of the internal data 111 from the internal data provider 108 may be performed using FTP or HTTP or may be performed using general file sharing or a database. Further, the internal data provider 108 and the modeling device 101 may be connected via the interface 203. Thus, the external data 110 and the internal data 111 are read to the modeling device 101 and the CPU 201 stores the external data 110 and the internal data 111 in the database 106.

Step 802 is a process in which the CPU 201 of the modeling device 101 reads the mathematical model information 113. Information of the mathematical model information 113 is generated in advance by manpower or the like in accordance with property of a modeling target and the information is read and stored in the database 106. The information may be read by registering data from a keyboard, a file, or a network using function of general database software.

Step 803 is a process in which the CPU 201 of the modeling device 101 executes a program of the modeling processing unit 103, performs modeling, and stores an execution result in the region partition information 114 and the statistical model information 112. This process will be described with reference to FIGS. 9A and 9B. Step 804 is a process in which the CPU 201 of the modeling device 101 displays the result on the display 206.

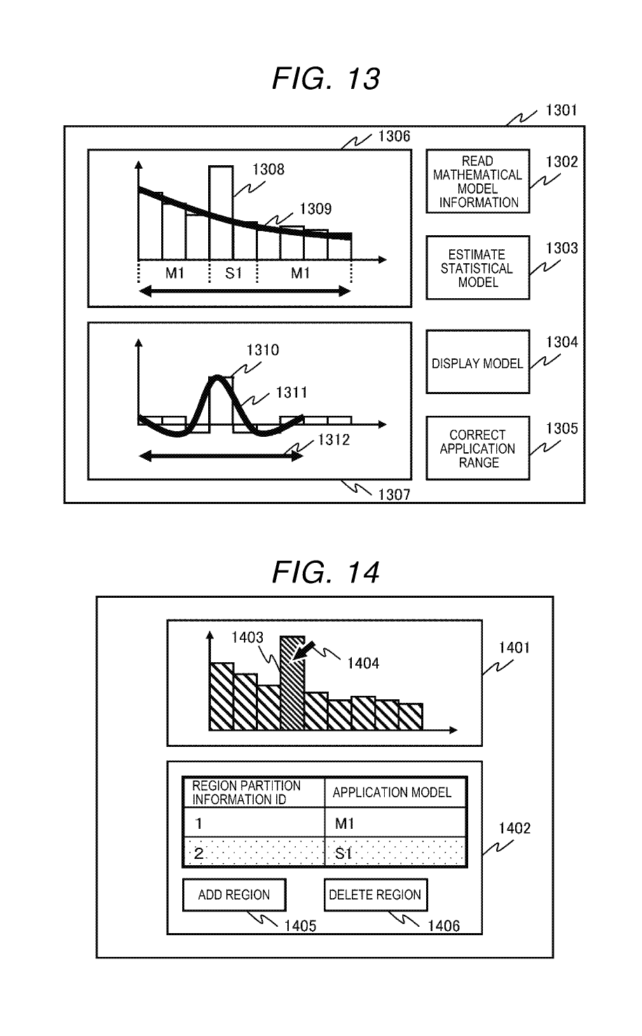

An example of a model input, estimation, and correction screen will be described with reference to FIG. 13. A screen 1301 illustrated in FIG. 13 is an example of a screen displayed when the modeling is performed and constituted by including a mathematical model information reading button 1302, a statistical model estimation button 1303, a model display button 1304, an application range correction button 1305, a mathematical modeling window 1306, and a statistical modeling window 1307.

The mathematical model information reading button 1302 is a button used to instruct to read mathematical model information, the statistical model estimation button 1303 is a button used to instruct to estimate a statistical model, the model display button 1304 is a button used to instruct to display a model, and the application range correction button 1305 is a button used to instruct to correct an application range. Step 802 may be performed in response to an instruction of the mathematical model information reading button 1302 or step 803 may be performed in response to an instruction of the statistical model estimation button 1303.

The mathematical modeling window 1306 is a modeling window on which a modeling situation by a mathematical model is displayed, and an observation value 1308 and a mathematical modeling estimation value 1309 are displayed for each target region or a target point. Here, the observation value 1308 is an actually observed value. The mathematical modeling estimation value 1309 is a result estimated by the mathematical model. The application model ID 703 may be displayed at each target point or one or two or more target regions displayed on the mathematical modeling window 1306 and may be displayed in response to an instruction of the model display button 1304.

The statistical modeling window 1307 is a window on which a modeling situation by a statistical model is displayed. A residual 1310, a statistical model estimation value 1311, and a model application range 1312 are displayed for each target region or target point. Here, the residual 1310 is a difference between the mathematical model estimation value 1309 and the actual observation value 1308 and the statistical model estimation value 1311 is an estimation value by a statistical model estimated from the residual by the mathematical model. The model application range 1312 is an arrow indicating an application model of a model. The arrow is expanded or contracted to correct the application range of the model and the application range may be decided in response to an instruction of the application range correction button 1305. The application model ID 703 may be displayed on the statistical modeling window 1307.

On the screen 1301, an observation value, an estimation value of each model, a difference between the observation value and the estimation value, and an application range of the model can be displayed so that it is easy to understand the application range.

Next, the modeling process of step 803 illustrated in FIG. 8 will be described with reference to FIGS. 9A and 9B. Step 901 illustrated in FIG. 9A is a process in which the CPU 201 of the modeling device 101 extracts points in a target point collection one by one to set the point as a target point and determines there is an unprocessed point. Here, the target point collection is a collection of points which are modeling targets and are, for example, points included in a sum collection of the target region 702 of the region partition information 114. One point may be a point that represents one region of the target region 702.

When there is an unprocessed point as a determination result of step 901, the process proceeds to step 902. After the process is performed on each point, that is, when there is no unprocessed point, the process proceeds to step 908 illustrated in FIG. 9B. Step 902 is a process in which the CPU 201 of the modeling device 101 sets “0” in the model output at the target point extracted in step 901 to perform initialization. Here, the model output is a variable that retains a value which is an output of the modeling process flow. Thereafter, addition is repeated using the model output as the variable and the value of the variable is finally set as an output result at the target point.

Step 903 is a process in which the CPU 201 of the modeling device 101 extracts the mathematical model 602 included in the mathematical model information 113 one by one, sets the mathematical model 602 as a target mathematical model, and determines whether there is an unprocessed mathematical model 602. When there is unprocessed mathematical model 602 as a determination result of step 903, the process proceeds to step 904. After the process is performed on each mathematical model 602, that is, when there is no unprocessed mathematical model 602, the process proceeds to step 906.

Step 904 is a process in which the CPU 201 of the modeling device 101 determines whether the target is included in the target region 603 of the target mathematical model. When it is determined that the target point is included in the target region 603 as a determination result of step 904, the process proceeds to step 905. When it is determined that the target point is not included in the target region 603, the process returns to step 903 and another target mathematical model is processed.

Step 905 is a process in which the CPU 201 of the modeling device 101 calculates an output of the target mathematical model at the target point and adds the output to the variable of the model output at the target point. In this calculation, the information of the external data 110 and the internal data 111 read in step 801 is applied and an expression of the mathematical model 602 serving as target mathematical model is used. Instead of performing step 801, the external data 110 and the internal data 111, in which the coordinate position of the target point matches the oil well positions 302 and 402, may be read in step 905.

Step 906 is a process in which the CPU 201 of the modeling device 101 determines whether a difference between the observation value and the value of the model output at the target point is equal to or less than a threshold. When it is determined that the difference is equal to or less than the threshold as a determination result of step 906, the process proceeds to step 907. When it is determined that the difference is not equal to or less than the threshold, the process returns to step 901 and another target point is processed.

Here, the threshold is a value used to determine whether the modeling may be performed as a mathematical model, and is set in advance by the operator or the like. The observation value may be the production quantity (p) 303 of the external data 110 or the production quantity (p) 405 of the internal data 111 read in step 801 or may be read in step 906 instead of performing step 801.

Step 907 is a process in which the CPU 201 of the modeling device 101 marks the target point as a mathematical model region. As the process, a matrix that takes a value of 0 or 1 for determining whether each point is a mathematical model or not may be written as an initial value 0 for all the elements in the memory 202 and a value of a matrix element corresponding to the target point may be set to 1. The mathematical model information ID 601 of the target mathematical model may be set in the application model ID 703.

Step 908 illustrated in FIG. 9B is a process in which the CPU 201 of the modeling device 101 determines whether there is a point at which the difference between the value of the model output and the observation value is equal to or greater than the threshold. When it is determined that there is the point at which is equal to or greater than the threshold as a determination result of step 908, coordinate positions of the model output and the observation value of which is determined to be equal to or greater than the threshold are set as the target points and the process proceeds to step 909. When it is determined that there is no point at which is equal to or greater than the threshold, the process proceeds to step 913. Here, the threshold is a value used to determine whether modeling may be performed as a statistical model and is set in advance by the operator or the like.

Step 909 is a process in which the CPU 201 of the modeling device 101 extracts the statistical model 502 included in the statistical model information 112 one by one, sets the statistical model 502 as target statistical model, and determines whether there is an unprocessed statistical model 502. When there is the unprocessed statistical model 502 as a determination result of step 909, the process proceeds to step 910. After the process is performed on each statistical model 502, that is, when there is no unprocessed statistical model 502, the process returns to step 908 and another target point is processed.

Step 910 is a process in which the CPU 201 of the modeling device 101 calculates the statistical model parameter 503 by applying the difference between the value of the model output and the observation value to the statistical model 502. In the application to the statistical model 502, a least-squares method or the like may be used. There is a general statistical software that has a function of estimating a parameter from data and a model (a model such as the statistical model 502 in which a parameter is not determined), and the statistical software may be used.

Therefore, plurality of target point may be extracted in step 908. For example, plurality of target point at which the difference is determined to be equal to or greater than the threshold and at which a distance between the coordinate positions is equal to or less than a preset value may be extracted, or plurality of target point at which is determined to be equal to or greater than the threshold and which do not include coordinate position of a point at which is less than the threshold between the coordinate positions may be extracted.

In addition, (a, b) of the statistical model parameter 503 may be obtained by the least-squares method or the like by setting the coordinate positions of the plurality of target points may be set as “(x, y).” Which statistical model is applied among plurality of statistical model 502 in the statistical model information 112 may be set in advance to be limited.

Step 911 is a process in which the CPU 201 of the modeling device 101 stores the calculated statistical model parameter in the statistical model parameter 503 of the statistical model information 112. In practice, this is a process of adding a new record in which the statistical model parameter 503 is determined to the statistical model information 112 using the database 106.

Step 912 is a process in which the CPU 201 of the modeling device 101 calculates an output of the target statistical model at the target point and adds the output to the variable of the model output at the target point. The calculation of the output of the target statistical model is calculation performed applying the coordinate position and the statistical model parameter 503 of the target point to an expression of the statistical model 502 serving as the target statistical model.

Step 913 is a process in which the CPU 201 of the modeling device 101 stores which model should be applied to each point included in the target point collection in the region partition information 114. The application of all the models contributing to the variable of the model output is registered in the region partition information 114. The statistical model information ID 501 serving as the target statistical model in step 912 may be stored in the application model ID 703.

After step 913, the region partition information 114 may be corrected by an operator. Thus, an example of a screen for a manual input used for the correction will be described with reference to FIG. 14. A correction window (region partition information display) 1401 illustrated in FIG. 14 is a window on which the region partition information is displayed for correction input. A region partition information display window 1402 is a window on which the region partition information is displayed with a different format from the correction window 1401.

A peculiar observation value 1403 is an observation value that is actually observed and does not obey a model that is obeyed by peripheral observation values. A pointer 1404 is a marker for allowing the operator to select an observation value by moving in conjunction with movement of a mouse 207 of the operator, a region addition button 1405 is a button used to define a new region from the selected observation value, and a region deletion button 1406 is a button used to delete selected region partition information.

The operator can determine, for example, that the peculiar observation value 1403 does not obey peripheral observation values, and change an application model or separate to another region while viewing the screen illustrated in FIG. 14. For example, the CPU 201 may control the change in the application model such that the peculiar observation value 1403 designated with the point 1404 is detected, a display density of the region partition information ID 2 and the application model S1 corresponding to the peculiar observation value 1403 on the region partition information display window 1402 is changed, the application model S1 corresponding to the peculiar observation value 1403 is changed to another application model based on information regarding the application model input from the keyboard 205 in this display state.

The CPU 201 may control partition of the region such that a designation of the region addition button 1405 is detected and the region of the region partition information ID 2 is partitioned in the state in which the display density of the region partition information ID 2 and the application model S1 corresponding to the peculiar observation value 1403 on the region partition information display window 1402 is changed. The CPU 201 may control deletion of the region such that a designation of the region deletion button 1406 is detected and the region of the region partition information ID 2 is deleted in the state in which the display density of the region partition information ID 2 and the application model S1 corresponding to the peculiar observation value 1403 on the region partition information display window 1402 is changed.

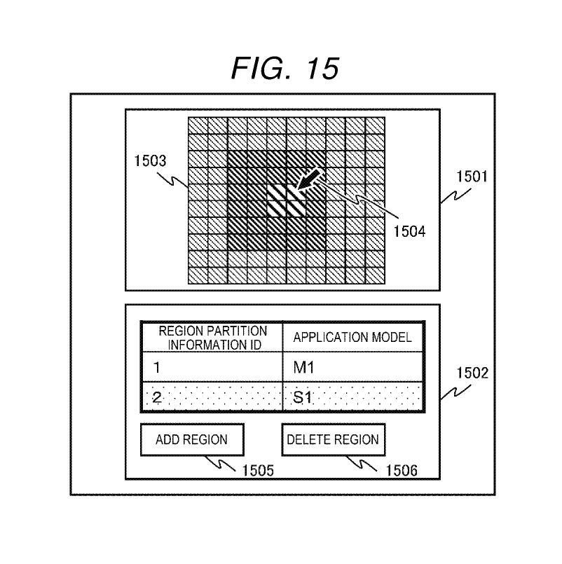

An example of another screen for a manual input used for the correction will be described with reference to FIG. 15. Each of a correction window 1501, a region partition information display window 1502, a pointer 1504, a region addition button 1505, and a region deletion button 1506 are the same as each of the correction window 1401, the region partition information display window 1402, the pointer 1404, the region addition button 1405, and the region deletion button 1406 described with reference to FIG. 14. Thus, the description thereof will not be repeated.

An observation value 1503 indicates that a ground surface is expressed 2-dimensionally and is partitioned into small regions, and an observation value of each small region is expressed with a display density. FIG. 15 illustrates an example of the square small region, but the invention is not limited to the square and a polygon may be used. A region of the target region 702 may be expressed by a plurality of small regions.

For example, when four small regions pointed by the pointer 1504 on the observation value 1503 have a display density indicating a peculiar observation value, a designation of one of the four small regions may be detected with the point 1504 and the process described with reference to FIG. 14 may be performed by the CPU 201. When a designation of the region addition button 1505 is detected, a direction (x, y) in which the region is partitioned may be input and the region may be partitioned in the input direction.

In this way, an operation based on a further real state can be performed by enabling display and input 2-dimensionally.

The modeling process has been described above. Hereinafter, a prediction process will be described. The prediction process is a process of predicting a predetermined point using a model after the modeling process. FIG. 10 is a diagram illustrating an example of a prediction process flow of the system according to the embodiment.

Step 1001 is a process in which the CPU 201 of the modeling device 101 reads the external data 110 and the internal data 111 from the external data provider 109 and the internal data provider 108 via the network 107. This process is the same process as step 801 in the modeling process. Step 1002 is a process in which the CPU 201 of the modeling device 101 reads the mathematical model information 113. This process is also the same process as step 802 in the modeling process.

Step 1003 is a process in which the CPU 201 of the modeling device 101 executes a program of the prediction processing unit 104, identifies a region including a prediction calculation target point using the region partition information 114, and performs prediction calculation using the statistical model information 112 or the mathematical model information 113 to be applied to the identified region. This process will be described below with reference to FIG. 11.

Step 1004 is a process in which the CPU 201 of the modeling device 101 displays a result on the display 206. The screen is the same as that in the example of FIG. 13 and a prediction result is displayed using the mathematical model estimation value 1309 and the residual 1310, and the statistical model estimation value 1311.

Next, step 1003 illustrated in FIG. 10 will be described with reference to FIG. 11. Step 1101 illustrated in FIG. 11 is a process in which the CPU 201 of the modeling device 101 extracts points in the target point collection one by one, sets the points as target points, and determines whether there is an unprocessed point. Here, the target point collection is a collection of points which are prediction targets and may be set by the operator or the like.

When there is an unprocessed point as a determination result of step 1101, the process proceeds to step 1102. After the process is performed on each point, that is, when there is no unprocessed point, the process ends. Step 1102 is a process in which the CPU 201 of the modeling device 101 sets 0 in the model output at the target point extracted in step 1101. Here, the model output is the same variable as that of step 902.

Step 1103 is a process in which the CPU 201 of the modeling device 101 extracts regions included in the region partition information 114 one by one, sets the region as target region, and determines whether there is an unprocessed region. When there is the unprocessed region as a determination result of step 1103, the process proceeds to step 1104. After the process is performed on each region, that is, when there is no unprocessed region, the process proceeds to step 1107.

Step 1104 is a process in which the CPU 201 of the modeling device 101 determines whether the target is included in the target region of the mathematical model. When it is determined that the target point is included in the target region as a determination result of step 1104, the process proceeds to step 1105. When it is determined that the target point is not included in the target region, the process returns to step 1103 and another target region is processed.

Step 1105 is a process in which the CPU 201 of the modeling device 101 acquires a model of the application model ID 703 in which the target region extracted in step 1103 is the target region 702, and the model to be applied is specified through this acquisition. Statistical model information ID 501 of the statistical model information 112 and the mathematical model information ID 601 of the mathematical model information 113 are retrieved based on the specified model, that is, the acquired model ID, and information regarding a matching statistical model or mathematical model is acquired from the statistical model information 112 or the mathematical model information 113.

Step 1106 is a process in which the CPU 201 of the modeling device 101 calculates an output of the model at the target point and adds the output to the variable of the model output at the target point. The model used for the calculation here is the model specified in step 1105 and is calculated by applying the information of the external data 110 and the internal data 111 read in step 1001 and the coordinate position of the target point to the information acquired in step 1105.

When information necessary in the model is insufficient at the target point, the insufficient information may be estimated from information around the target point. In this case, the information around the target point is not used without changed, but may be apportioned, for example, by a distance between the target point and a point at which there is information.

Step 1107 is a process in which the CPU 201 of the modeling device 101 sets the value of the model output as the prediction calculation result at the target point.

The prediction calculation has been described above. Finally, modeling correction will be described. By continuing to learn for actual administration after the modeling, it is possible to make prediction with higher precision. FIGS. 12A and 12B are diagrams illustrating an example of a modeling correction process flow according to the embodiment. Step 1201 illustrated in FIG. 12A is a process in which the CPU 201 of the modeling device 101 executes a program of the modeling correction processing unit 105 and is the same process as step 901, including the target point collection.

Step 1202 to step 1206 are the same processes as step 1102 to step 1106. However, since the process equivalent to step 1107 is not performed in the modeling correction process, the process returns to step 1201 when there is no unprocessed region as a determination result of step 1203.

Step 1207 illustrated in FIG. 12B is a process in which the CPU 201 of the modeling device 101 determines whether there is a point at which the difference between the value of the model output and the observation value is equal to or greater than the threshold. When it is determined that there is the point at which the difference between the value of the model output and the observation value is equal to or greater than the threshold as a determination result of step 1207, modeling correction is necessary, and thus coordinate positions of the model output and the observation value of which is determined to be equal to or greater than the threshold are set as the target points and the process proceeds to step 1208. When it is determined that there is no point at which the difference between the value of the model output and the observation value is equal to or greater than the threshold, it is not necessary to correct the model and the process proceeds to step 1212. Here, the threshold is set in advance by the operator or the like.

Step 1208 to step 1212 are the same processes as step 909 to step 913. Step 1213 is a process in which the CPU 201 of the modeling device 101 sets the value of the corrected and newly generated model output in the prediction calculation result at the points included in the target point collection.

As described above, it is possible to perform the modeling in which the statistical model and the mathematical model are used together. The model can be adopted for each region. Therefore, even when there is a peculiar observation value, modeling appropriate for a region of the peculiar observation value can be performed separately from the other regions, and thus the peculiar observation value can be utilized.

Further, it is possible to predict a value of a new coordinate position using the modeling result. It is possible to correct the modeling in accordance with addition of a new model or a change of the observation value over time.

### 4. CONCLUSION

The invention is not limited to the foregoing embodiments and various modification examples are included. For example, the foregoing embodiments have been described in detail to easily describe the invention and all of the described configurations may not necessarily be included.

Some or all of the foregoing configurations, functions, processing units, and processing mechanisms may be realized in hardware by, for example, designing with integrated circuits or the like. The foregoing configurations, functions, and the like may be realized in software by causing a processor to analyze and execute a program realizing the functions. Information such as a program, a table, and a file realizing each function may be stored in a recording device such as a memory, a hard disk, or a solid state drive (SSD) or a recording medium such as an IC card, an SD card, or a DVD.

What is claimed is:

1. A modeling device that models observation data, the modeling device comprising:
a database unit that stores a mathematical model based on environment data obtained from the observation data, a statistical model based on a parameter, and region information including each point at which the observation data is obtained;
a data reading unit that acquires the observation data and the environment data; and
a modeling processing unit that applies the mathematical model or the statistical model, wherein
the modeling processing unit calculates a model output by applying the acquired environment data to the mathematical model at each point included in the region information, and
when a difference between the calculated model output and the acquired observation data is determined to be equal to or greater than a preset threshold, the modeling processing unit calculates a parameter from the acquired observation data and applies the statistical model using the calculated parameter.

2. The modeling device according to claim 1, wherein
in the database unit, a plurality of mathematical models and regions in which the plurality of mathematical models are set as targets are associated to be stored, and
the modeling processing unit acquires a point included in the region information and applies the mathematical model associated with the region including the acquired point.

3. The modeling device according to claim 2, wherein
the modeling processing unit acquires a point included in the region information, and
when the acquired point is included in a plurality of regions, the modeling processing unit applies the mathematical models associated in each of the plurality of regions, adds model outputs calculated in each of the mathematical models, and sets the added model output as a model output.

4. The modeling device according to claim 3, wherein
when a difference between the added model output and the acquired observation data is determined to be equal to or greater than a preset threshold, the modeling processing unit calculates a parameter from the acquired observation data, applies the statistical model using the calculated parameter, and records the application of the statistical model in the region information in association with the acquired point.

5. The modeling device according to claim 4, wherein
when the acquired point is included in a plurality of regions, the modeling processing unit records the application of the mathematical model associated in each of the plurality of regions in the region information in association with the acquired point.

6. The modeling device according to claim 5, further comprising:
a display unit that displays the added model output and the acquired observation data in an overlapping manner and displays a difference between the added model output and the acquired observation data and a value calculated by applying the statistical model in an overlapping manner.

7. The modeling device according to claim 6, wherein
the region information is geographic information and the point included in the region information is a point expressed by a coordinate position.

8. The modeling device according to claim 7, further comprising:
a prediction processing unit that uses the region information in which the application of the statistical model or the application of the mathematical model is recorded, wherein
the prediction processing unit specifies the statistical model or the mathematical model recorded in the region information at each prediction target point, and
the prediction processing unit calculates a model output by applying the specified statistical model or the mathematical model.

9. The modeling device according to claim 8, wherein
the prediction processing unit specifies the plurality of statistical models or the plurality of mathematical models recorded in the region information at each prediction target point, and
the prediction processing unit calculates model outputs by applying the plurality of specified statistical models or the plurality of specified mathematical models respectively, adds the calculated model outputs respectively to set the added model output as a model output.

10. The modeling device according to claim 9, further comprising:
a modeling correction processing unit that corrects the region information in which the application of the statistical model and the application of the mathematical model are recorded, wherein
the modeling correction processing unit specifies the statistical model or the mathematical model recorded in the region information at each point included in the region information,
the modeling correction processing unit calculates a model output by applying the specified statistical model or the mathematical model, and
when a difference between the calculated model output and the acquired observation data is determined to be equal to or greater than a preset threshold, the modeling correction processing unit calculates a parameter from the acquired observation data and applies the statistical model using the calculated parameter.
